(19) United States
(12) Patent Application Publication
(10) Pub. No.: US 2002/0149518 A1
(43) Pub. Date: Oct. 17, 2002

(54) Distance estimation between transmitter and receiver

(76) Inventors: Kari Haataja, Oulu (FI); Mikko Jarvela, Coppell, TX (US)

Correspondence Address: PILLSBURY WINTHROP, LLP, P.O. BOX 10500, MCLEAN, VA, 22102, US

(21) Appl. No.: 10/083,668

(22) Filed: Feb. 27, 2002

Related U.S. Application Data
(63) Continuation of application No. PCT/FI00/00740, filed on Sep. 1, 2000.

(30) Foreign Application Priority Data
Sep. 2, 1999 (FI) 19991870

(51) Int. Cl. G01S 1/24; G01S 3/02

(52) U.S. Cl. 342/458; 342/387

(57) ABSTRACT

A radio system comprising a base station and a terminal, said base station and terminal being able to serve as a transmitter and the other as a receiver, a signal to be transmitted on a radio channel between the transmitter and the receiver comprising bursts including a training sequence known to the receiver, the receiver comprising means for creating, on the basis of the training sequence a radio channel impulse response comprising taps representing signal strength at different points of time. The receiver further comprising means for calculating the real time of arrival of the burst from the time of occurrence and energy of the taps of the impulse response, means for creating the time difference between the real and expected times of arrival of the burst, and means for calculating the distance between the transmitter and the receiver on the basis of the time difference.

This application is a Continuation of International Application PCT/FI00/00740 filed Sep. 1, 2000 which designated the U.S. and was published under PCT Article 21(2) in English.

### FIELD OF THE INVENTION

The invention relates to a radio system and to a method of estimating the distance between a transmitter and a receiver in the radio system. The invention relates particularly to radio systems, in which bursts including a training sequence known to a receiver are transmitted to the receiver.

### BACKGROUND OF THE INVENTION

As the properties of mobile networks and mobile stations increase, attention is also paid to methods of measuring the distance between a mobile station and a base station, and of locating a mobile station within the area of a mobile network. Determining the location of a mobile station is of importance for example for public authorities, for instance in rescuing and tracing a user of a mobile station. As regards the mobile network, the location and a change in the location are of importance for example in planning handover and allocation of radio resources when a mobile station roams the area of the radio network.

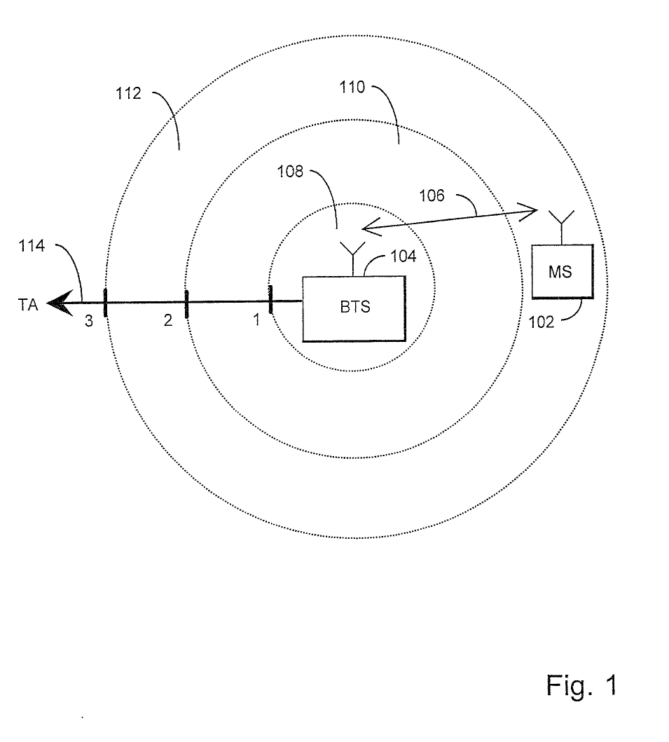

In the GSM (Global System for Mobile communication) system, in which in overlapping cells are composed of the coverage areas of base stations, the variation in the sizes of the cells may be between a diameter of a few meters in pico cells in an office environment to a diameter of 35 km in cells in sparsely inhabited areas. In large cells, the distance between mobile stations and the base station may thus be long, which means that radio bursts transmitted by terminals on a radio connection also have to travel distances of very different lengths. In order for a radio burst received by a receiver to arrive at the receiver as close to the instant expected by a receiving party as possible, the transmitter has to allow for the distance between the transmitter and the base station when transmitting the radio burst to the radio path. A terminal close to a receiver, such as a base station, does not have to reserve as much timing advance as does a terminal at the edge of a cell. FIG. 1 shows, by way of example, a prior art solution for measuring the distance of mobile stations in the area of a known GSM network. The figure shows a mobile station 102 and a serving base station 104, which communicate on a bi-directional radio connection 106. The figure shows the use of a timing advance TA 114 in a radio network for determining the distance between a mobile station and a base station. Terminals located within an area 108 do not have to transmit their bursts in advance, i.e. the timing advance of the terminals located within the area 108 is zero. The timing advance of the terminals within an area 110 is one, which means that they have to transmit a burst using an advance corresponding to one bit, and a terminal within an area 112 has to allow for an advance corresponding to a 2-bit transmission in its transmissions. The value of the TA allows the base station to roughly estimate the distance between a terminal and the base station: a TA value of one corresponds to a distance of about 550 meters, a TA value of two corresponds to a distance of about 1100 meters and so forth; i.e. the distance is calculated by formula TA*550 meters. Owing to multipath propagation, the distance of a mobile station, calculated on the basis of the TA, may differ from that presented.

A serious drawback in the prior art is that the distance between a mobile station and a base station cannot be estimated sufficiently accurately in order to obtain an adequate basis for determining the location of a mobile station within the area of a cellular radio network.

### BRIEF DESCRIPTION OF THE INVENTION

It is thus an object of the invention to provide an improved method and an apparatus for implementing the method of estimating the distance between a transmitter and a receiver in a radio system. This is achieved by a method to be presented next. A method is provided of estimating the distance between a transmitter and a receiver in a radio system, the method comprising transmitting to the receiver bursts including a training sequence known to the receiving party in a signal to be transmitted on a channel in the radio system, and producing a channel impulse response in the receiver on the basis of the training sequence. In the method, the real time of arrival is calculated by statistical methods from the time of occurrence of the taps of the impulse response and from the energy of the taps, the time difference between the real and expected times of arrival of the burst is created in the receiver, and the distance between the transmitter and the receiver is calculated on the basis of the time difference.

The invention also relates to a radio system comprising at least one base station and at least one terminal within the coverage area of the base station, at least one of said base station and terminal being able to serve as a transmitter and the other as a receiver, the connection between the transmitter and the receiver being established by means of a radio channel; a signal to be transmitted on said radio channel comprising bursts composed of symbols, the bursts including a training sequence known to the receiver, the receiver comprising means for taking samples from the received signal and means for creating, on the basis of the training sequence in the burst, a radio channel impulse response comprising taps representing signal strength at different points of time. The receiver in the radio system comprises means for calculating the real time of arrival of a burst by statistical methods from the time of occurrence of the taps of the impulse response and from the energy of the taps, means for creating the time difference between the real and expected times of arrival of the burst, and means for calculating the distance between the transmitter and the receiver on the basis of the time difference.

In a radio system, information is transmitted between a transmitter and a receiver over radio channels. Radio systems, in which the entire frequency band is not reserved for one user, employ the time division multiple access method, for example, whereby a user is allocated a given timeslot at a certain frequency for transmission or reception of information. The information to be transmitted in the timeslot is packed as a burst to the radio path. In a base station-based radio network, an uplink transmission direction is separated for radio traffic, whereby a terminal, such as a mobile station, a portable computer or the like, transmits information in the direction of the base station. Similarly, a downlink transmission direction refers to information transmitted by the base station to a terminal.

The propagation time of burst transmitted on a radio channel depends on the distance between the transmitter and the receiver. In a typical cellular radio network, such as the GSM, the distances between a base station and mobile stations within the coverage area of the base station may vary from meters to dozens of kilometers, and therefore a mechanism is required to enable the receiver to receive the burst it is expecting as close to the time expected as possible. For this reason, some radio systems employ a mechanism based on a timing advance, wherein the receiver informs the transmitter that it should transmit the burst at a given timing advance depending on the distance between the transmitter and the receiver. In this case, a mobile station located far away from the base station has to transmit its burst at a longer timing advance than a mobile station located close to the base station. Similarly, the base station allows for the timing advance in its transmissions such that when transmitting to a terminal located far away, the base station uses a longer timing advance than for a terminal located nearby. Conventionally the timing advance has been determined by basing the calculation on a window of a few taps, for example five, giving the best transmit power and taken from the impulse response of a signal to be transmitted on a radio channel. The prior art solution for calculating the timing advance for estimating the distance of a mobile station is inaccurate since the timing advance is not even adapted for use in estimating distances. For example in the GSM system, more accurate methods of calculating the timing advance are not even needed since the values the timing advance obtains are integers and changes in the timing advance are known to be expressed on a three-step scale: value −1 means that the terminal is to advance its transmission with one bit, value 0 means that no changes in the timing of the transmission are needed, and value 1 means that the terminal is to delay its transmission with one bit.

In a typical cellular radio environment, signals between a base station and a subscriber terminal propagate along several paths between a transmitter and a receiver. This multipath propagation is mainly caused by the signal being reflected from surrounding surfaces. Signals that have propagated along different paths arrive at the receiver at different times owing to different propagation delays. This applies to both transmission directions. The multipath propagation of a signal can be observed in a receiver by measuring for the signal received an impulse response in which the signals arrived at different times are seen as peaks proportional to their signal strength. The impulse transmitted is seen in the impulse response as multipath-propagated components, called taps of the impulse response. For example in the GSM system, an impulse response graph is used for calculating the timing advance. In known solutions, the impulse response is estimated by means of a training sequence, which is added to the burst and known to the transmitter and the receiver. A training sequence is composed of a number of symbols in a burst, often in the middle of the burst, known to the transmitter and the receiver. In known solutions, such as in the GSM system, the impulse response is estimated by cross correlation of samples received and a known training sequence. The receiver generates a channel impulse response for a received burst by means of the training sequence in the burst.

The basic idea of the invention is to use the taps of the impulse response to calculate the deviation of the impulse response in relation to the expected time of arrival of the burst represented by the impulse response. For example the weighted average can be used as the calculation method, whereby the times of appearance of the taps are weighted by the strength of the signal, i.e. tap, at that particular point of time. The invention employs the centre of gravity of the impulse response in determining the distance between a mobile station and a base station.

The invention provides a plurality of advantages. The invention allows the distance between a mobile station and a base station to be estimated accurately compared with the use of a timing advance, for example. This provides a reliable basis for methods by means of which the location of a terminal can be very accurately determined.

### BRIEF DESCRIPTION OF THE INVENTION

In the following the invention will be described in greater detail with reference to examples according to the attached drawings, in which

FIG. 1 shows a prior art example of estimating the distance between a terminal and a base station,

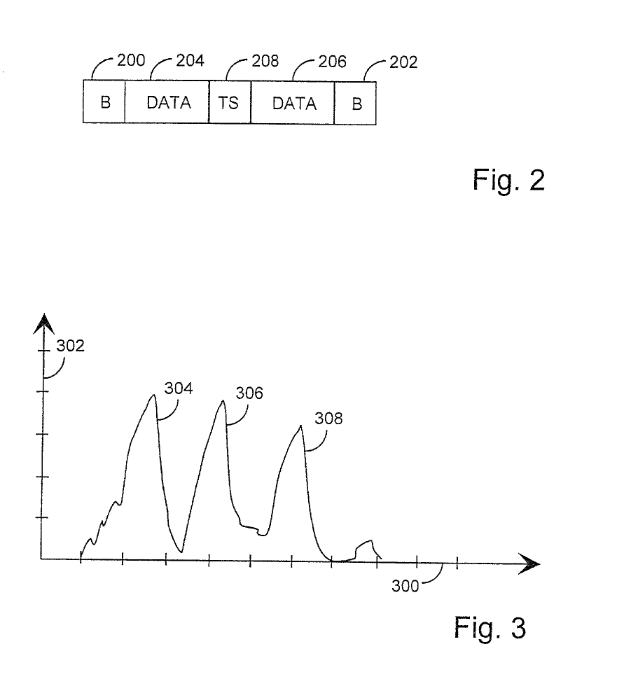

FIG. 2 shows a normal burst in the GSM system,

FIG. 3 illustrates the impulse response generated on the basis of a signal,

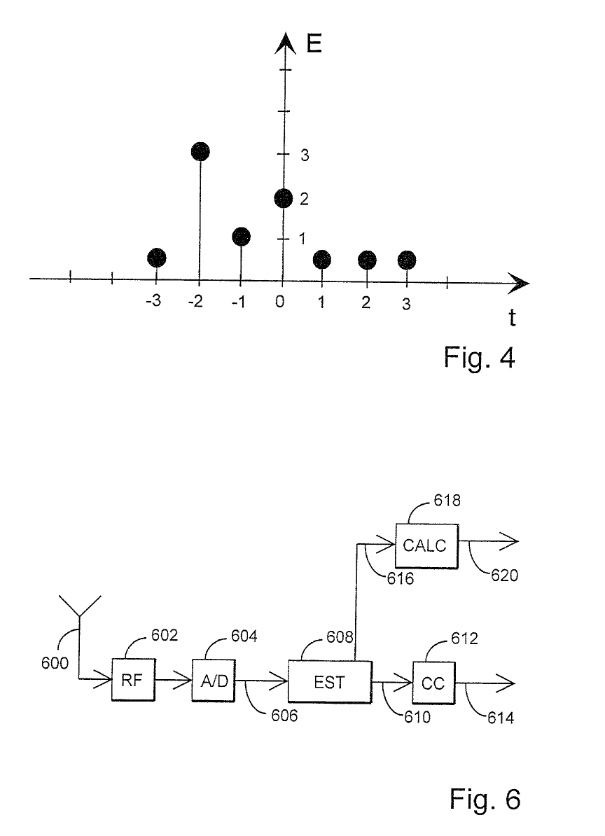

FIG. 4 shows an example of the energy taps of an impulse response as a function of the time of occurrence of the taps,

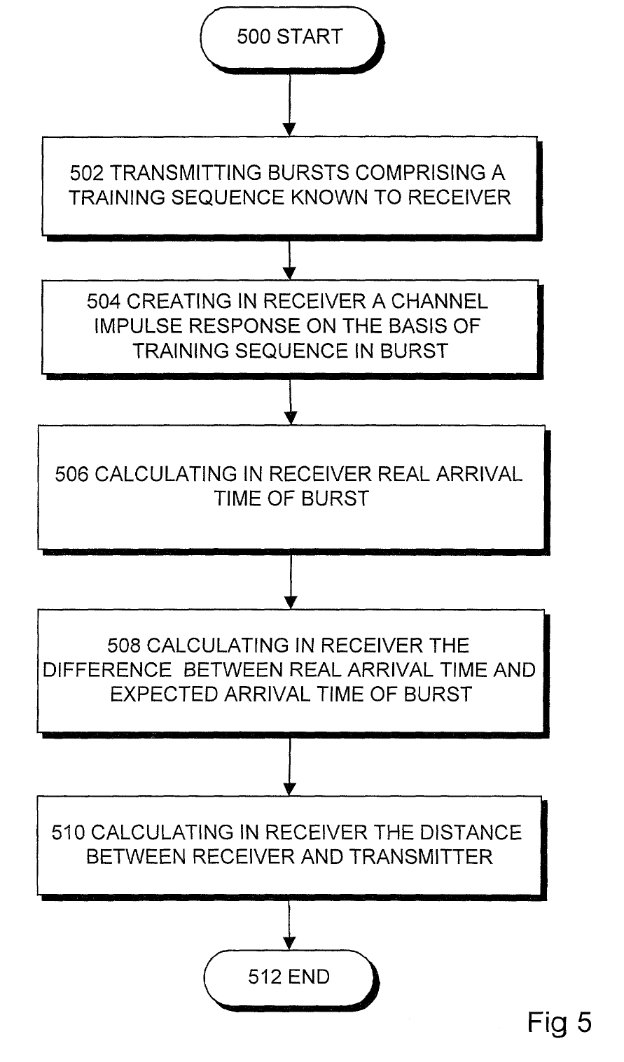

FIG. 5 is a flow diagram of the method of the invention in accordance with a preferred embodiment,

FIG. 6 shows a preferred embodiment of the apparatus of the invention, and

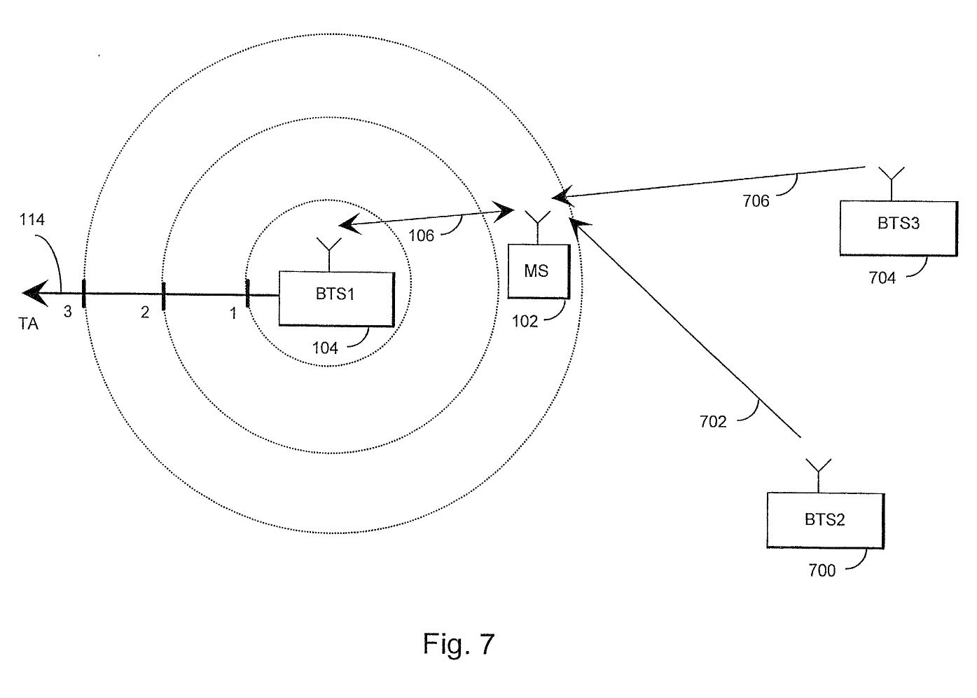

FIG. 7 shows an application field for the solution of the invention.

### DETAILED DESCRIPTION OF THE INVENTION

The invention is applicable to any digital radio system in which a burst includes a training sequence. An example of such systems is the GSM cellular radio system, and it is used below in the description of the invention as an example without, however, restricting the invention thereto.

According to their multiple access method, digital radio systems are dividable into three main categories. In the frequency division multiple access (FDMA) system, a frequency band is reserved for each user, on which only said user is able to communicate during a connection. In systems applying the code division multiple access method, a spreading code is reserved for each user for distinguishing user information from other radio traffic on the radio path. In systems applying the time division multiple access method, different users operating on the same frequency band are distinguished from each other temporally: the entire frequency band is reserved for a given user at a given point of time, and for another user at the next point of time. In a radio system using the time division multiple access method, synchronization between the radio network and the terminals is vital for the transmitter to be able to transmit a burst at the point of time expected by the receiver and, similarly, for the receiver to be able to receive the burst at the right time. In the GSM, a dedicated control channel SCH (Synchronization Channel), is reserved for synchronization. In addition to the above three main categories of multiple access methods, different multiple access methods can be combined in a radio system. The GSM system, which is used as an example, is based on time and frequency division multiple access methods.

A bi-directional radio link between a radio system and a terminal is composed of uplink and downlink transmission directions. Uplink refers to radio traffic from a terminal to a base station, whereas downlink refers to radio traffic from a base station to a terminal. A bi-directional radio link can be implemented based on, for example, time division duplex (TDD) or frequency division duplex (FDD). In the TDD, uplink and downlink are implemented on the same frequency band by means of timeslot division such that, at a given point of time, communication is uplink, whereas at another point of time, communication is downlink. In the FDD, different frequency ranges implement the uplink and downlink transmission directions. The GSM system is implemented using the FDD.

In known solutions, the impulse response is thus estimated by means of a known training sequence added to a burst. FIG. 2 shows by way of example a normal burst in the GSM system, comprising head and tail bits 200, 202, actual data in two parts 204, 206, and a training sequence 208 located in the middle of the burst. In a normal burst, the length of the training sequence is 26 bits. In the GSM system, the training sequence is located in the middle of the burst, this being the best position for it to describe the radio channel interference the burst has undergone. Should the training sequence be located for example at one edge of the burst next to the head or tail bits, it would not describe the radio channel equally advantageously during the transmission time of the burst.

The impulse response is calculated in accordance with prior art, and the way the impulse response is generated it is not essential to the invention. One way of generating the impulse response is to minimize the square of the difference between samples calculated by means of the samples formed from the signal and the impulse response estimate, allowing for N bits at a time in the calculation. The error function can be expressed as follows:

$${e}^{2} = {\sum }_{k = j}^{j + N} {( y ( k ) - Y )}^{2}$$

wherein y(k) denotes samples received and j is the start of the bit string to be observed at each particular time. The error value used above is thus the square of the difference (MSE, minimum squared error). The error thus calculated is minimized. Minimization can be carried out by different methods described in literature, such as LMS, Kalman, direct matrix inversion etc. For example in the LMS method, the gradient of the above function is taken and an iterative solution is searched for in the direction of the gradient. In principle, the square of the error can be minimized by means of only the difference without calculating the actual square.

FIG. 3 shows an example of a signal received on a radio channel. In the coordinates, the y-axis 302 represents the strength of a received signal and the x-axis 300 the time the signal was received in the receiver. The figure shows that three peaks 304, 306 and 308 have been amplified from the signal in the example, and they have arrived at the receiver at different times owing to multipath propagation. The low peak to the right after peak 308 is significantly lower than said three peaks, and thus the lower peak could be ignored in an impulse response graph to be created on the basis of the signal.

FIG. 4 shows a signal converted into an impulse response graph. The meanings of the axes of the coordinates correspond to those shown in FIG. 3, i.e. the y-axis represents signal power level and the x-axis the measurement time of the impulse tap. The zero point of the x-axis represents the time when the receiver expects to receive a user's burst. Adapted to for example the GSM mobile telephone system, the zero point represents the point of time when the base station receives a timeslot in which the burst of a mobile station should arrive. The zero point of the x-axis can also be adapted to the current value of the timing advance. Consequently, a discrete impulse response graph corresponding to FIG. 4 is formed from the continuous signal of FIG. 3, even though the signal data of FIGS. 3 and 4, shown by way of example, do not correspond. In accordance with the invention, a value representing the deviation of the taps is created from the impulse response graph by statistical methods. For example, the value representing the deviation may be a weighted average, which is calculated by formula (1):

$$\overline{t} = \frac{1}{{{\sum }_{n}}^{m} E ( t )} \times {{\sum }_{n}}^{m} [ t \times E ( t ) ] , wherein \qquad ( 1 )$$

\overline{t} denotes the centre of gravity of the impulse response graph, E(t) denotes the energy of the impulse response tap at time t, and n and m denote the starting and ending points of time of the calculation of the impulse response taps.

Adapted to the example of FIG. 4, formula (1) can be written as

$$\overline{t} = \frac{1}{{{\sum }_{- 3}}^{3} E ( t )} \times {{\sum }_{- 3}}^{3} [ t \times E ( t ) ] ,$$

and when the energies and times of the impulse response taps are inserted, we get

$$\overline{t} = \frac{1}{0.5 + 3 + 1 + 2 + 0.5 + 0.5 + 0.5} ( - 3 \times 0.5 - 2 \times 3 - 1 \times 1 + 2 \times 0 + 1 \times 0.5 + 2 \times 0.5 + 3 \times 0.5 ) \approx - 0.69$$

In FIG. 4, it is feasible that the zero point of the x-axis is located in point 1 of the timing advance TA. Since the result −0.69 is negative, the conclusion can be made that the terminal is in fact located closer than the 550 meters corresponding to the estimated value 1 of the TA. Thus the obtained distance of the mobile is 550−(0.69*550)=122 meters from the base station. By rounding off to the nearest value of the timing advance, the value of the timing advice could thus also be changed from one to zero. The use of the timing advance as the zero point of the x-axis is not necessary; instead, the zero point could be placed for example at that point of time when the burst should arrive at the timing advance zero. In this case the value of the centre of gravity is always positive, since it takes time for the burst to propagate over the radio path to the receiver.

Further, should a larger number of samples than only one value of the centre of gravity be used in the calculation of the centre of gravity, the method used could be for example a moving average. The centre of gravity would then always be calculated on the basis of, say, the last 10 values in accordance with formula (2).

$$\overline{T} = \frac{1}{m - n} \times {\sum }_{n}^{m} {t}_{n} , \qquad ( 2 )$$

, wherein \overline{T} denotes a second average calculated from the group of samples of the centre of gravities, n denotes the first index of the group of samples, and m denotes the last index of the group of samples.

The method of the invention is described by means of a preferred embodiment in FIG. 5. In the initial step 500 of the method, a terminal, for example a mobile station, is located within the coverage area of a base station in a cellular radio network. In other words, the mobile station serves as the transmitter and the base station as the receiver, even though the implementation of the functionality of the invention for measuring the distance also allows the terminal to serve as the receiver and the base station as the transmitter. In method step 502, the transmitter transmits to the receiver on a radio network channel a burst including a training sequence known to the receiving party. It is not essential to the invention on which channel said burst is transmitted; it could be a shared channel, a dedicated channel, a control channel or another channel of the system. In step 504, the channel impulse response is created in the receiver on the basis of the training sequence in the received radio burst. The impulse response is created in a known manner, and the way it is created is not essential to the invention. In step 506, the taps of the impulse response obtained in accordance with the invention are used to generate a value for the real time of arrival of the burst using probabilistic methods. In step 508, the real time of arrival of the burst obtained in step 506 is utilized by calculating the difference between the actual and expected times of arrival of the burst. In a preferred embodiment, for example in the GSM, the expected time of arrival is the timeslot in which the burst is expected to arrive. The probabilistic method is for example a weighted average, calculated as the weighted average of the impulse response tap energy and the time of occurrence of the taps, in accordance with formula (1). In step 510, the distance between the transmitter and the receiver is calculated by multiplying the weighted average by the time taken by the transmission of a bit. For example in the GSM system, the transmission of one bit takes 0.0037 ms, corresponding to a distance of about 550 meters. In the final step 510, the distance between the mobile station and the base station has been calculated and the result can be utilized in other routines, such as in calculations determining the location of a mobile station. It is not essential to the present invention how the result obtained is utilized.

Let us next study an example of the structure of a receiver according to the invention, the essential parts of the structure being illustrated in the block diagram of FIG. 6. Both a base station and a subscriber terminal may serve as a receiver according to the invention. The receiver comprises an antenna 600 for applying a received signal to radio frequency parts 602, in which the signal is converted into an intermediate frequency. From the radio frequency parts, the signal is applied to converter means 604, in which the signal is converted from analog into digital by sampling. A digital signal 606 propagates to estimation means 608, in which the channel impulse response is estimated by cross correlation of samples with the training sequence. The estimation means 608 restore the signal distorted in the channel to the original data stream of the signal at a symbol error probability that depends on the interference factors, such as interference caused by adjacent bits received. Taps of the estimated channel impulse response are then generated from the impulse response data with the estimation means. The above functions can be implemented for example with general or signal processors and suitable software or with logic components. In the estimation means 308, the channel is further detected for example by a Viterbi detector. The Viterbi output is used to make hard bit decisions on the basis of the impulse response.

The detected signal is further applied to a channel decoder 612 and from there further 614 to other parts of the receiver. A calculation unit 618 according to the invention receives impulse response information 616 and calculates the centre of gravity of the impulse response graph. The distance of the mobile from the base station calculated on the basis of the taps of the impulse response graph is obtained as an output 620 from the calculation unit, and this information can be utilized for example by methods and apparatuses locating the mobile.

As is obvious to a person skilled in the art, the receiver of the invention naturally comprises other components besides the ones described above, such as filters, but they are not essential to the invention and not described for the sake of clarity.

FIG. 7 shows an area of application of the invention. FIG. 7 shows a mobile station 102 surrounded by three base stations 104, 700 and 704. The base station 104 serves the mobile station. A base station controller BSC, which communicates with all base stations BTS1 to BTS3, coordinates the base stations. Based on the known triangle measurement method, once the distance between the mobile station and all three base stations is known by means of radio link 106, 702, 706, the exact location of the mobile station can be determined. In the example described, a mobile station can serve as the receiver, and it would also then calculate the distances. Alternatively, the BSC, for example, can calculate the distances. The present invention only serves to provide a method of measuring the distance between a terminal and a base station; the rest of the logic required in the application example described above is not within the scope of the present invention.

Even though the invention is described above with reference to the example according to the attached drawings, it is obvious that the invention is not restricted thereto, but can be modified in a variety of ways within the scope of the inventive idea disclosed in the attached claims.

1. A method of estimating the distance between a transmitter and a receiver in a radio system, comprising:
transmitting to the receiver bursts including a training sequence known to the receiving party in a signal to be transmitted on a channel in the radio system;
creating a channel impulse response in the receiver on the basis of the training sequence;
calculating the real time of arrival by statistical methods from the time of occurrence of the taps of the impulse response and from the energy of the taps;
creating in the receiver the time difference between the real and expected times of arrival of the burst; and
calculating the distance between the transmitter and the receiver on the basis of the time difference.

2. The method as claimed in claim 1, comprising:
calculating in the receiver a second average on the basis of the weighted averages of the times of arrival of two or more bursts;
calculating the distance between the transmitter and the receiver by means of one of the averages.

3. A method as claimed in claim 1 or 2, comprising:
calculating in the receiver a timing advance for the transmitter on the basis of the received burst;
using the value of the timing advance as the expected time of arrival of the burst;
changing the timing advance on the basis of the real time of arrival calculated on the basis of the impulse response and the expected time of arrival calculated on the basis of the timing advance.

4. The method as claimed in claim 1, 2 or 3, wherein
the statistical method used in calculating the real time of arrival is a weighted average calculated by the formula
$$\overline{t} = \frac{1}{{{\sum }_{n}}^{m} E ( t )} \times {{\sum }_{n}}^{m} [ t \times E ( t ) ] .$$

5. The method as claimed in claim 1, wherein the radio system is a digital cellular radio network employing the time division multiple access method, and that said burst is transmitted in a timeslot of a radio channel in the cellular radio network, and that the expected time of arrival of the burst is the time of reception of the timeslot.

6. The method as claimed in claim 1, wherein the transmitter is a mobile station and the receiver is a base station.

7. A radio system comprising at least one base station and at least one terminal within the coverage area of the base station, at least one of said base station and terminal being able to serve as a transmitter and the other as a receiver, the connection between the transmitter and the receiver being established by means of a radio channel; a signal to be transmitted on said radio channel comprising bursts composed of symbols, the bursts including a training sequence known to the receiver, the receiver comprising means for taking samples from the received signal and means for creating, on the basis of the training sequence in the burst, a radio channel impulse response comprising taps representing signal strength at different points of time, the receiver comprising:
means for calculating the real time of arrival of the burst by statistical methods from the time of occurrence of the taps of the impulse response and from the energy of the taps;
means for creating the time difference between the real and expected times of arrival of the burst, and
means for calculating the distance between the transmitter and the receiver on the basis of the time difference.

8. The radio system as claimed in claim 7, the receiver comprising:
means for calculating a second average on the basis of the weighted averages of the times of arrival of two or more bursts, and
means for calculating the distance between the transmitter and the receiver by means of one of the averages.

9. The radio system as claimed in claim 7 or 8, the receiver comprising:
means for calculating a timing advance for the transmitter on the basis of the received burst;
means for using the value of the timing advance as the expected time of arrival of the burst; and
means for changing the timing advance on the basis of the real time of arrival calculated on the basis of the weighted average of the impulse response and the expected time of arrival calculated on the basis of the timing advance.

10. The radio system as claimed in claim 7, 8 or 9, wherein the statistical method used in the calculation of the real time of arrival is a weighted average calculated by the formula
$$\overline{t} = \frac{1}{{{\sum }_{n}}^{m} E ( t )} \times {{\sum }_{n}}^{m} [ t \times E ( t ) ] .$$

11. The radio system as claimed in claim 7, wherein the radio system is a digital cellular radio network employing the time division multiple access method, and that the burst is transmitted in a timeslot of a radio channel in the cellular radio network, and that the expected time of arrival of the burst is the time of reception of the timeslot of the radio channel.

12. The radio system as claimed in claim 7, wherein said transmitter is a mobile station and said receiver is a base station.
